(19) United States
(12) Patent Application Publication
(10) Pub. No.: US 2016/0058655 A1
(43) Pub. Date: Mar. 3, 2016

(54) SYSTEM AND METHOD FOR PREVENTATIVE-CONDITIONING SOFT TISSUE ACTUATION

(71) Applicant: Performance Dynamics, Inc., Muncie, IN (US)

(72) Inventor: Thomas L. Sevier, Muncie, IN (US)

(21) Appl. No.: 14/476,361

(22) Filed: Sep. 3, 2014

(51) Int. Cl. A61H 15/00

(52) U.S. Cl. CPC A61H 15/0092; A61H 2201/501; A61H 2201/1253

(57) ABSTRACT

A method and/or system of preventative/conditioning soft tissue actuation applied on a person without diagnosed illness or injury is disclosed. It utilizes at least one hand-held instrument, wherein said instrument is separate or distinct from the hands of an individual applying the method. The instrument is topically applied to non-invasively deliver pressures and shear forces to the soft tissue of the person in pre-determined protocol sessions and the instrument is applied with primarily longitudinal strokes across the soft tissue structure of the person.

### BACKGROUND

In the 1990s, what became the Astym® therapy research team began to investigate how topical pressures and shear forces could affect underlying dysfunctional soft tissue structures. In a radical departure from current practice and theories, instruments were applied to the body in an effort to induce measurable and meaningful change in function via physiological mechanisms. The course of this research led the team to focus on inducing a regenerative/reparative response in soft tissues through the topical application of instruments. At the time, the current wisdom was that regeneration of tissues was not a possible or a feasible option. The idea of stimulating a regenerative, reparative response induced into the body through the topical application of instruments was considered impossible, and the Astym therapy research team was the subject of widespread criticism from the medical and therapy community for their endeavor.

Through a significant investment of time, effort and resources, the Astym research team was able to identify specific protocols wherein topical pressures and shear forces are applied with instrumentation to induce a reparative and regenerative response. Today, Astym therapy is widely accepted as a normal and important part of patient care, and routinely resolves conditions where other treatments fail. Astym therapy shows impressive results for a wide range of soft tissue injury and dysfunction, and there is an abundance of documented accounts detailing of how Astym therapy improves quality of life. Following the success of Astym therapy, others attempted imitation, and used tools for soft tissue injury, but the imitators never achieved the effectiveness of Astym therapy, and instead induced a significant amount of injury on patients. Astym therapy remains the only safe and effective instrumented soft tissue treatment for injury. In the course of research confirming the effectiveness of Astym treatment and detailing its impact on dysfunctional tissue, the researchers inadvertently discovered startling evidence that pressures and shear forces, applied in a very particular manner, can impact healthy tissue in a positive way. This surprising discovery has led the research team to pioneer a radical new approach in wellness/conditioning and injury prevention, which is embodied herein.

### SUMMARY

The present invention is defined by the claims and only the claims. However, it may include a method and/or system of preventative management for people. It comprises of identifying and listing activity or prevention categories and providing a listing of intervention protocols for the corresponding category. The intervention protocols include intervention duration, the number or frequency of intervention sessions during the duration, and the direction and location of the instrumented portion of the intervention. It includes categorizing a person into at least one of the activity or prevention categories and then assessing, associating, scheduling and possibly performing intervention protocol(s) upon the person. No clinical decision making is involved in this method/system of preventative management. Diagnoses and treatment of injury or illness are not part of this system, and should be performed separately from this system.

These and other features are provided.

### BRIEF DESCRIPTION OF THE DRAWINGS

FIG. 1 is a flowchart for an embodiment of a method of preventative soft tissue management for people.

FIG. 2 is a flowchart for an embodiment of a method of preventative soft tissue management for people.

FIG. 3 is a schematic drawing of portions of an embodiment of the system for a preventative program for people.

FIG. 4 illustrates one example of an embodiment of a readable table for associating program protocols with the manner in which the individual was selected for the program.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

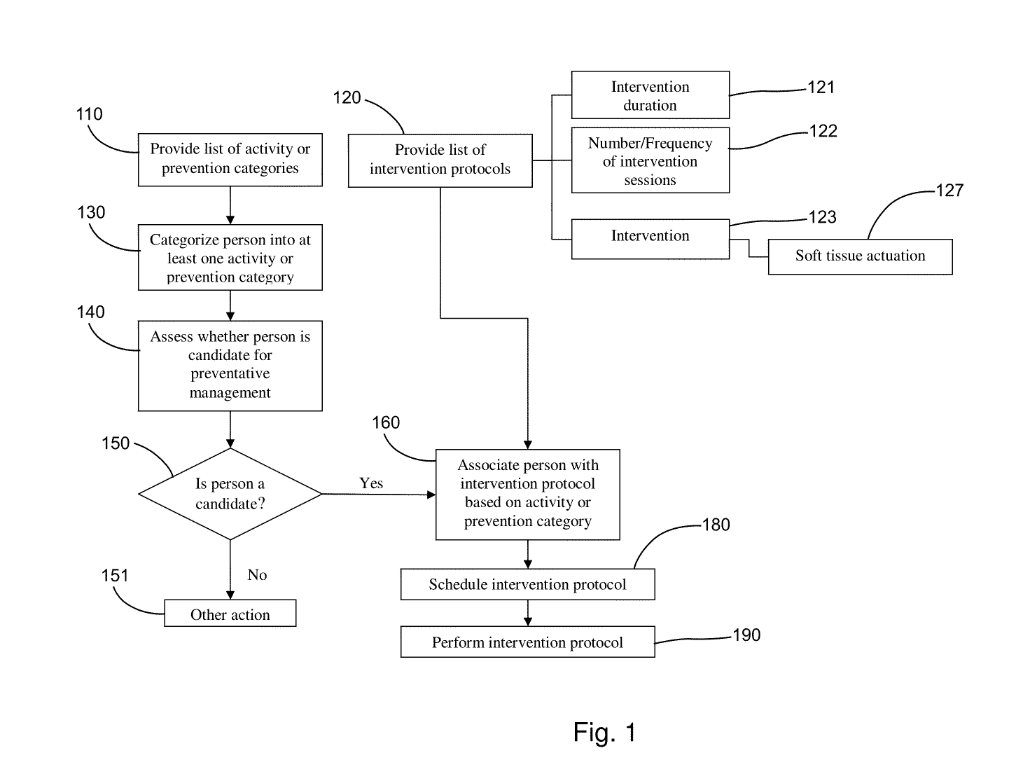

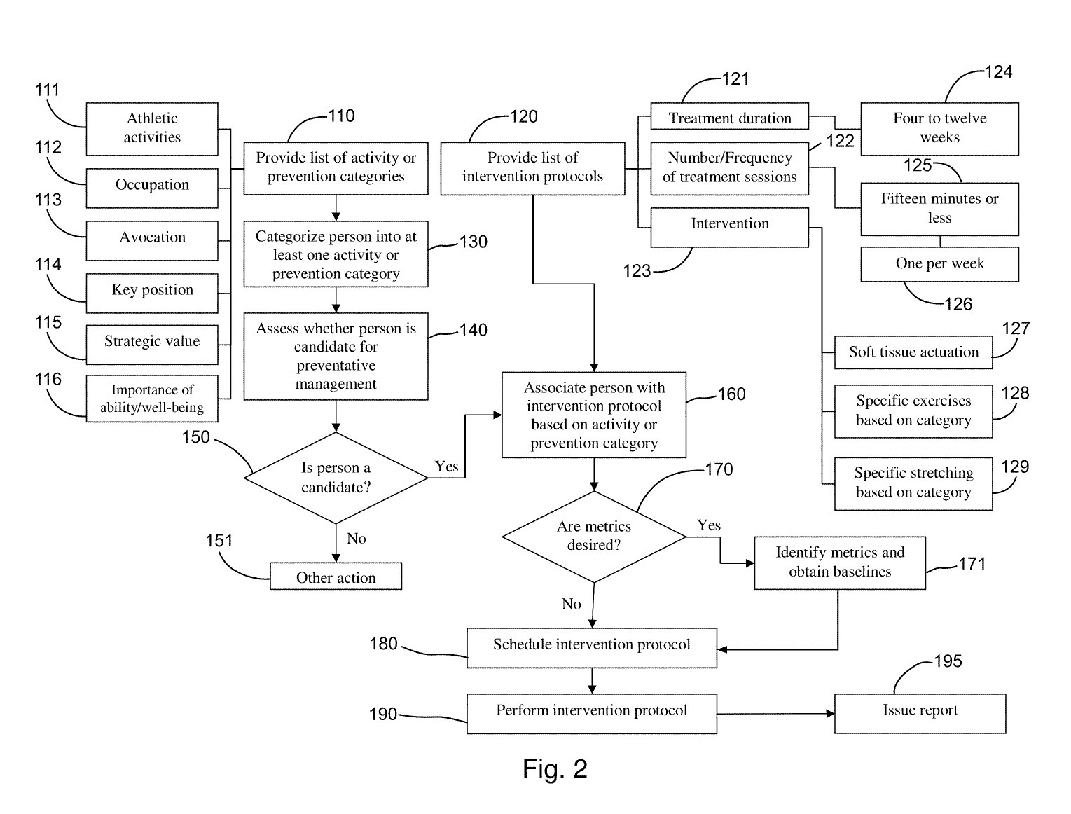

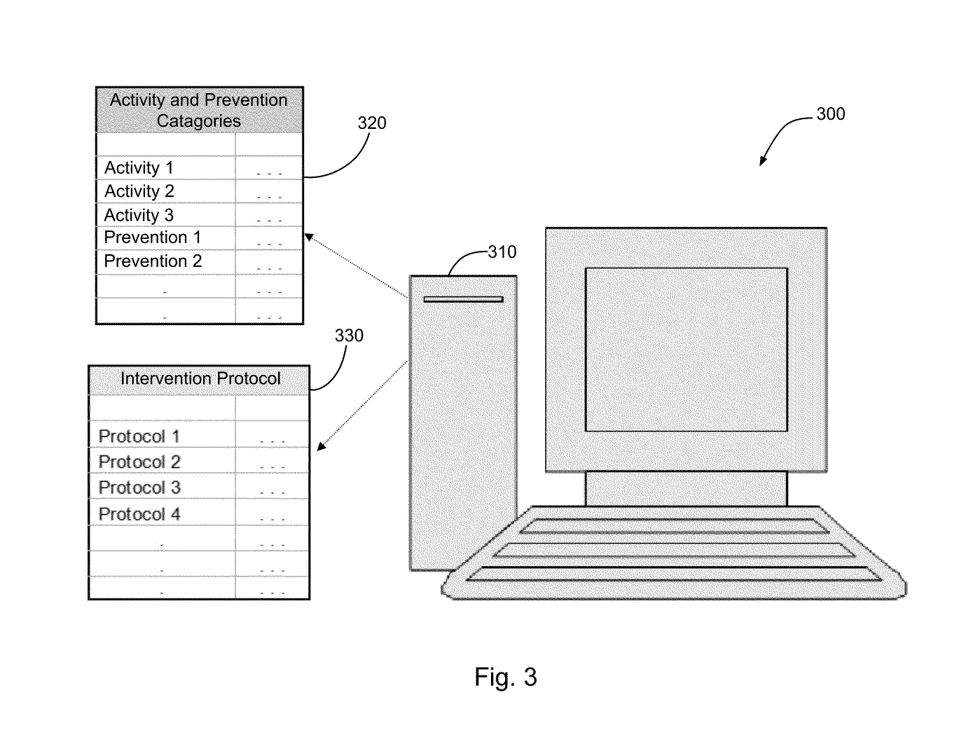

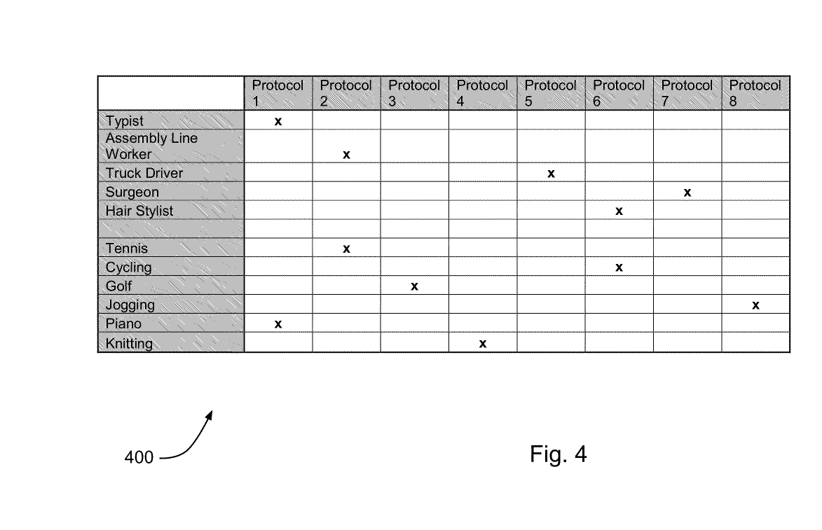

With reference to the drawings (FIGS. 1-4) a method of preventative management for people is provided. This method is applied to individuals without diagnosed injury or illness and provides an approach to achieve optimal performance of the body by stimulating, strengthening, adapting, and improving soft tissues, which include structures that support the bones and joints, such as muscles, tendons, ligaments and fascia. The method may comprise the acts of providing 110 a listing of separate activity or prevention categories and providing 120 a listing of intervention protocols. The intervention protocols include intervention duration 121, the number or frequency of intervention sessions 122 during the duration, and the intervention 123 to be performed which may include soft tissue actuation 127 via extracorporeal instrument pressure strokes.

The act of categorizing 130 a person into at least one of the categories of activity or prevention categories and then assessing 140 whether the person is a candidate for preventative management is performed. If the person is a candidate 150, the person is associated 160 with an intervention protocol based on activity or prevention category. The assessing comprises determining whether the person has been diagnosed with an existent illness or injury in the location where the preventative management is desired, and whether such a diagnosis should eliminate the individual as a candidate for the preventative management program. The associating comprises associating the person based on the activity and prevention categories with at least one of the intervention protocols.

After associating 160 a person with an intervention protocol, then the scheduling 180 of at least one intervention protocol for the person and performing 190 the intervention protocol upon the person is performed. If, following the assessment, the person is determined not to be a candidate for the preventative management, for a reason such as a diagnosis of an existent illness or injury that would interfere with the preventative program or other contra-indication, then the person is not scheduled for an intervention protocol and is advised to take other action 151.

The method may comprise preventative management applied on a person without diagnosed illness or injury. This may include soft tissue actuation, in which at least one handheld instrument is utilized, wherein said instrument is separate or distinct from the hands of an individual applying the method, and topically applying the instrument to non-invasively deliver pressures and shear forces to soft tissue of the person in pre-determined protocol sessions. The instrument may be applied with primarily longitudinal strokes across the soft tissue structure of the person, with those strokes are applied in sets of two to eight strokes (or otherwise). The protocol sessions may be provided at a frequency of one to three times per week 126 with a duration of four to twelve weeks 124. Other session frequencies and/or durations are optional as well.

One or more features that are optional, but not required, may be wherein the intervention includes specific exercises 128 and/or specific stretches 129 pertaining to the associated activity or prevention category.

One feature that is optional, but not required, may be wherein the scheduling for the intervention includes at least one intervention session each week 126 and/or wherein at least one intervention session is scheduled to last about fifteen minutes or less 125.

One feature that is optional, but not required, may be that one of the activity or prevention categories is based on athletic activity 111, occupation 112, or avocation 113. Other optional factors on which the activity or prevention categories may be based is whether the person holds a key position 114 in a company, organization, or group; the person's strategic value 115; and/or the importance of ability/well-being 116 to the person.

One feature that is optional, but not required, may be that the listing of activity and prevention categories comprises a series of records stored in computer memory in a relational database first datatable, and the listing of intervention protocols also comprises a series of records stored in computer memory in a relational database second datatable. The act of associating includes computer data processing associating at least one common field from the first table and the second table.

One feature that is optional, but not required, may be that measurement metrics are desired 170 before beginning the intervention protocol. If metrics are desired, the metrics are identified and baselines are obtained 171. Then, a report is generated documenting the metrics and identifying the intervention protocol to be followed based on the association with the activity or prevention categories. If desired, but not required, a report 195 may be also generated after performing the intervention protocol 190.

One feature that is optional, but not required, may be that the soft tissue actuation via instrument pressure through the extracorporeal instrumented pressure strokes and provision of shear forces is from a generally rigid, hand-held instrument with at least one taper to a concentration point and/or edge. A variety of instruments may be used, and an example of such an instrument is illustrated in U.S. Pat. No. D660,449 S (hereby incorporated by reference). Other shapes and embodiments of hand held instrumentation may also be used.

One feature that is optional, but not required, may be that the extracorporeal instrument pressure strokes are applied by a person holding the hand-held instrument. The person uses the instrument to apply topical pressure affecting the underlying tissue of the person receiving the intervention. Other forms of the intervention are also available.

One feature that is optional, but not required, may be that a person is associated with an intervention protocol based on their activity or job duties. These activities or job duties could include historically high claims jobs or high-stress activities. The application of these protocols do not involve clinical decision making.

One feature that is optional, but not required, may be that a person is associated with an intervention protocol based on their need for prevention, protection or enhanced wellness. These needs could arise from a person being in a key position or having a strategic value, or otherwise having importance placed on ability and/or well-being. The application of these protocols do not involve clinical decision making.

One feature that is optional, but not required, is a system for preventative management for people that is documented in a computer format 300. It comprises an electronic computer 310 and a list of separate activity or prevention categories 320 stored on the electronic computer. The list of separate activity or prevention categories comprises a series of records stored in computer memory in a relational database first datatable. The system also comprises a list of categories of intervention protocols 330 stored on the electronic computer. The list of categories of intervention protocols prescribe intervention duration, the number and/or frequency of intervention sessions during the duration, and the type of intervention to be performed which may include soft tissue actuation, specific exercises, and/or stretches pertaining to the associated activity or prevention category which may be performed by the person as part of the intervention. The soft tissue actuation includes extracorporeal instrument pressure strokes. The list of intervention protocols comprises a series of records stored in computer memory in a relational database second datatable. The electronic computer associates at least one common field from the first datatable and the second datatable.

One feature that is optional, but not required, may be that the electronic computer generates a report identifying the intervention protocol based on its association with activity or prevention categories.

One feature that is optional, but not required, may be that the first datatable and the first second datatable are accessible from an internet based user interface.

One feature that is optional, but not required, may be that the categories of the avocations, athletic activities, occupations, key positions, strategic value, and/or importance of ability/well-being, and the intervention protocols are not stored on an electronic computer, but are stored in any form of a readable table 400 (paper, printout, or otherwise), so that associating these groups may be done without the use of an electronic computer.

In terms of the meaning of words or terms or phrases herein, literal differences therein are not superfluous and have different meaning, and are not to be synonymous with words or terms or phrases in the same or other claims. As used here (claims, specification, and other definitions) the following terms have the following meaning:

Articles and phases such as, “the”, “a”, “an”, “at least one”, and “a first”, “comprising”, “having” and “including” here are not limited to mean only one, but rather are inclusive and open ended to also include, optionally, two or more of such elements and/or other elements.

The term “and/or” is inclusive here, meaning “and” as well as “or”. For example, “P and/or Q” encompasses, P, Q, and P with Q; and, such “P and/or Q” may include other elements as well.

The term “athletic activities” means here any form of physical activity used to maintain or improve physical ability, engaging in athletics for employment or sport, or for entertainment. Examples include, without limitation, team sports, tennis and other racquet sports, running, boxing, weightlifting, or golf.

The term “associating” means here to connect or relate an item with another item.

The term “avocation” means here any hobby or a pastime that involves physical activity. Examples include, without limitation, gardening, knitting, or playing a musical instrument such as piano or drums.

The term “categorizing” means here the act of placing or indexing an item within one or more category or class.

The term “computer data processing” means here the use of electronic devices with microprocessors to carry out one or more operations on electronic data.

The term “computer memory” means writable and/or readable media to store programs or data on either a temporary or permanent basis.

The term “concentration point or edge” means here an edge or point of an object which is generally narrower than the main body of the object. It may be flat, pronounced, gradual, rounded, convex, concave or otherwise designed to engage the soft tissues of the body to transfer pressure and shear forces.

The phrase “consisting essentially of” means specified materials and/or ingredients and/or steps and/or acts and/or other elements, and to those that do not materially affect the invention's basic and novel characteristics in the claim (as a transition) or the element or the group.

The phrase “consisting of” means to only include exactly what is stated, and excludes any step, act, material ingredient, or element not specified in the claim (as a transition) or the element or the group.

The term “datatable” means here a table, in computer memory, with rows and columns that contains data in the form of separate records. The stored data may be alphanumeric or otherwise.

The term “diagnosing” means here for a qualified medical professional to identify an injury or an illness in a person or a patient after one or more of questioning, observing and or testing them.

The term “diagnosis is negative” means here that a person has been examined by a qualified medical professional and was found to likely have no existing injury or illness highly correlated to one or more repetitive motion task at the time of diagnosing.

The term “electronic computer” means here any machine and/or group and/or network of electronic machines with a microprocessor for making calculations or that may be programmed for carrying out logical operations. This could include, but is not limited to remote or local: desktop computer, server, tablet computer, cellular telephone, smart phone, or laptop.

The term “extracorporeal” means non-invasive, and applied topically to the human body of the person who is the subject of the intervention.

The term “exercise” means here any form of systematic, physical activity or movement to sustain or improve function, conditioning, and/or health of soft tissues. This includes without limitation lifting weights, isometrics, resistance training, stretching, or otherwise.

The term “frequency” means here the average rate of occurrence. This is determined by the number of events occurring within a given duration. The events may be temporally spaced at uniform intervals or not.

The term “hand-held instrument” means here a tool, instrument, implement or object that is sized so that it may be grasped by a human hand. It may be made of plastic or other stiff polymer, metal, ceramic, wood, a combination thereon, or otherwise.

The term “highly correlated” means having a Pearson's correlation coefficient of 0.6 or higher.

The term “injury or illness” means here an abnormal condition or disorder within the meaning of U.S. Federal OSHA regulation, 19 C.F.R. Sec. 1904.46.

The term “instrument pressure” means the application of concentrated force or weight via an instrument or implement.

The term “intervention” means here the nature and type of strokes, exercises and/or stretches.

The term “intervention duration” means here the period of time within which intervention sessions occur.

The term “intervention protocol” means the set of: (a) the type of intervention; (b) the intervention duration; and, (c) the number or frequency of intervention sessions.

The term “intervention session” means here a single meeting, visit, or period of time in which an intervention protocol is done.

The term “list” or “listing” means here a set of data, words, names, numbers, or any other item that is arranged in order.

The term “longitudinal strokes” means here, performing a non-invasive, topically applied stroke on the body with an instrument in the direction generally parallel to the soft tissue fibers. The soft tissue structure to which such strokes are applied may be, but is not limited to, muscle belly, tendon, or ligament length.

The term “means” and/or “means for” and/or “step” and/or “step for” here, if and when used in a claim, invokes 35 U.S.C. §112(f) means-plus-function for the recited function(s) and the corresponding structure(s) or act(s) (including alternatives in the definitions or elsewhere in this disclosure) and equivalents thereto.

The term “occupation” means here a job, vocation, career or any other activity that a person does as a source of income.

The term “performing” means here to carry out, to execute, to act, or to do.

The term “preventative management” means here conditioning, early intervention, wellness, health maintenance or care for a person, that has the purpose of preventing an injury, strengthening or conditioning the body, and/or achieving optimal performance of the body. The term includes, without limitation, a wellness, injury prevention, conditioning, and/or preventative soft tissue management program.

The term “providing” means here to create, to make available, to furnish, to supply, or to document.

The term “record” means here a separate set of data, typically kept as a row in a datatable.

The term “relational database” means here one or more computer databases having collectively at least two datatables that have at least one field in each that are associated with the other either directly or indirectly (such as, for example, by another table, query, data stringer, or operator).

The term “scheduling” means here to set dates and times in the future when one or more events will occur.

The term “separate” means here unique or distinct or to make items or records unique or distinct.

The term “set of strokes” means here the number of strokes it takes to traverse the length of the soft tissue being addressed. A set may mean one stroke along the soft tissue, but it may also include any higher number of strokes, for example 4 or 8 strokes. The strokes may or may not overlap.

The term “soft tissue actuation” means here an intervention approach for stimulus of soft tissues involving the use of an instrument or instruments to provide pressure and shear forces to soft tissues using primarily longitudinal strokes. It may be performed with hand-held instruments or any other type of instrument that can be used to apply pressure and shear forces on a soft tissue structure. The soft tissue that is subject to this process may be any tissue structure upon which the instrument may have effect, including but not limited to, muscle, tendon, fascia or ligaments. The goals of soft tissue actuation may be, but are not limited to, stimulating underlying neural, muscular, and/or connective tissues resulting in improved movement, strength, resilience, endurance, flexibility, health, and/or recovery of the soft tissue. The results of soft tissue actuation may be, but are not limited to, increasing the ability of soft tissue to tolerate activity, expand endurance, handle more load, and/or assist in safeguarding against future musculoskeletal pain, injury and/or dysfunction.

The term “stretches” means here any form of exercise in which a muscle or tendon is flexed or pulled gently to improve elasticity and/or range of motion.

The term “stroke” means here the act of topically moving an instrument in a path while applying instrument pressure and shear forces to the tissues of the body. The path may be straight, curved or otherwise.

The term “taper” means here to become smaller or thinner toward one end or point.

The invention may include any one or more articles or devices made by any of the claimed methods and/or may by different methods but with a claimed composition.

The language used in the claims and the written description and in the above definitions is to only have its plain and ordinary meaning, except for terms explicitly defined above. Such plain and ordinary meaning is defined here as inclusive of all consistent dictionary definitions from the most recently published (on the filing date of this document) general purpose Webster's dictionaries and Random House dictionaries.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A method of preventative management applied on a person without diagnosed illness or injury, comprising the acts of:
utilizing at least one hand-held instrument, wherein said instrument is separate or distinct from the hands of an individual applying the method;
topically applying the instrument to non-invasively deliver pressures and shear forces to soft tissue for actuation thereof of the person in pre-determined protocol sessions;
wherein said instrument is applied with primarily longitudinal strokes across the soft tissue structure of the person;
wherein said longitudinal strokes are applied in sets of two to eight strokes;
wherein said protocol sessions are provided at a frequency of one to four times per week; and,
wherein said protocol sessions last a duration of four to twelve weeks.

2. The method of claim 1, wherein said protocol session includes exercises.

3. The method of claim 1, wherein said protocol session includes stretching.

4. The method of claim 1, wherein said protocol session is scheduled to last about fifteen minutes or less.

5. The method of claim 1, further comprising the act of generating a report identifying said pre-determined protocol sessions to be performed on the person.

6. The method of claim 1, wherein said instrument is a generally rigid, hand-held instrument with at least one taper to a concentration point or edge.

7. The method of claim 1, wherein said pre-determined protocol sessions are determined by activities performed by the person.

8. The method of claim 7, wherein one category of said activities is avocation.

9. The method of claim 7, wherein one category of said activities is occupation.

10. The method of claim 7, wherein one category of said activities is athletic activities.

11. A method of preventative soft tissue management comprising the acts of:
(1) providing a listing of activity or prevention categories;
(2) providing a listing of intervention protocols, said intervention protocols including:
(i) intervention duration;
(ii) number or frequency of intervention sessions during said duration; and,
(iii) intervention, wherein said intervention includes soft tissue actuation;
(3) assessing whether said person is a candidate for preventative soft tissue management, wherein if said person is a candidate:
(4) associating said person with at least one of said intervention protocols based on one of said activity or prevention categories;
(5) scheduling at least one intervention protocol for said person; and,
(6) performing said intervention protocol upon said person.

12. The method of claim 11, wherein said intervention includes specific exercise pertaining to the associated activity or prevention category.

13. The method of claim 11, wherein said intervention includes specific stretching pertaining to the associated activity or prevention category.

14. The method of claim 11, wherein at least one intervention session of said intervention protocol is scheduled to last about fifteen minutes or less.

15. The method of claim 11, wherein said scheduling for said intervention protocol includes at least one session per week.

16. The method of claim 11, wherein said intervention duration is at least four weeks.

17. The method of claim 11, wherein said associating further comprises associating said person with at least one intervention protocol based on condition of said person.

18. The method of claim 11, wherein said listing of intervention protocols comprises a series of records stored in computer memory in a relational database datatable.

19. The method of claim 11, wherein said soft tissue actuation includes instrument pressure that is applied to said person with longitudinal strokes.

20. The method of claim 19, wherein said longitudinal strokes are provided in sets of at least two.

21. A system for preventative management for people comprising:
A hand-held therapy instrument;
an electronic computer;
a list of separate activity and/or prevention categories stored on said electronic computer, wherein said list of activity and/or prevention categories comprises a series of records stored in computer memory in a relational database first datatable,
a list of categories of intervention protocols stored on said electronic computer, wherein said list of categories of intervention protocols prescribe:
(i) intervention duration;
(ii) number or frequency of intervention sessions during said duration; and,
(iii) intervention, wherein said intervention is accomplished through extracorporeal instrumented pressure and shear force strokes;
wherein said list of intervention protocols comprises a series of records stored in computer memory in a relational database second datatable; and,
wherein said electronic computer associates at least one common field from said first datatable and said second datatable.

22. The system described in claim 21, wherein said electronic computer generates a report identifying said intervention protocol based on said association with said activity and prevention categories.

23. The system described in claim 21, wherein said first datatable and said first second datatable are accessible from an internet based user interface.
